(19) United States
(12) Patent Application Publication
(10) Pub. No.: US 2010/0254049 A1
(43) Pub. Date: Oct. 7, 2010

(54) CIRCUIT INTERRUPTER DEVICE

(75) Inventors: Guo-lan YUE, Shanghai (CN); Cheng-li LI, Shanghai (CN); Xiao-ming ZHANG, Shanghai (CN)

Correspondence Address: Chen Yoshimura LLP;Attention Ying Chen, 333 W. El Camino Real, Suite 380, Sunnyvale, CA, 94087, US

(73) Assignee: SHANGHAI JIA AO ELECTRIC CO., LTD., Shanghai (CN)

(21) Appl. No.: 12/467,138

(22) Filed: May 15, 2009

Related U.S. Application Data
(60) Provisional application No. 61/167,114, filed on Apr. 6, 2009.

(30) Foreign Application Priority Data
Apr. 16, 2009 (CN) 200910049476.3

(51) Int. Cl. H02H 3/02; H02H 3/16

(52) U.S. Cl. 361/42; 361/49

(57) ABSTRACT

A circuit interrupter device includes a first, a second and a third electrical conductive path, a fault detection circuit for generating a fault detection signal based on a fault detected in at least the first electrical conductive path, a first disconnect mechanism connected to the fault detection circuit, for disconnecting the first electrical conductive path and the second electrical conductive path based on the fault detection signal, and a second disconnect mechanism connected to the first electrical conductive path, for connecting or disconnecting the second electrical conductive path and the third electrical conductive path based on a wiring condition of the circuit interrupter device.

This application claims priority from U.S. Provisional Patent Application No. 61/167114, filed Apr. 6, 2009, which is herein incorporated by reference in its entirety.

This application claims foreign priority benefits under 35 U.S.C. §119(a)-(d) from China Patent Application No. 200910049476.3, filed Apr. 16, 2009, which is incorporated by reference in its entirety.

### BACKGROUND OF THE INVENTION

1. Field of the Invention

This invention relates to a protection device for electrical equipment, and in particular, it relates to circuit interrupter device.

2. Description of the Related Art

With the increased safety standard for electrical equipment, ground fault circuit interrupters (GFCI), arc fault circuit interrupters (AFCI) and other types of leakage current protection devices are widely used. Many such circuit interrupter devices with leakage current protection can detect leakage current between phase and neutral lines, and when the leakage current reaches certain levels, can disconnect the electrical connection between the output and input ends of the device.

Some conventional circuit interrupters have a reverse-wiring protection function. An exemplary GFCI with reverse-wiring protection includes an input side (for connecting to the line power), an output side (for connecting to a load), an output receptacle (for receiving prongs of a plug), and four switches formed by four pairs of contacts. Two pairs of the contacts are for electrically connecting the input side and the output side; the other two pairs of contacts are for electrically connecting the input side and the output receptacle. The four pairs of contacts are connected or disconnected together. Because the space inside these circuit interrupter devices is small, arcs are often formed when the four pairs of contacts are subject to large currents, which adversely impact the electrical insulating properties of the electrical components and plastic parts inside the circuit interrupter devices. Further, due to the repeated opening and closing of the four pairs of contacts during long term use, the contacts themselves often experience oxidization and wear, affecting the life of the circuit interrupter.

### SUMMARY OF THE INVENTION

The present invention is directed to a circuit interrupter device that substantially obviates one or more of the problems due to limitations and disadvantages of the related art.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, the present invention provides a circuit interrupter device which includes: a first, a second and a third electrical conductive path; a fault detection circuit for generating a fault detection signal based on a fault detected in at least the first electrical conductive path; a first disconnect mechanism connected to the fault detection circuit, for disconnecting the first electrical conductive path and the second electrical conductive path based on the fault detection signal; and a second disconnect mechanism connected to the first electrical conductive path, for connecting or disconnecting the second electrical conductive path and the third electrical conductive path based on a wiring condition of the circuit interrupter device.

According to one embodiment, the first disconnect mechanism includes a first switch set, which includes two pairs of contacts for connecting the phase and neutral conductors of the first and second electrical conductive paths, respectively; the second disconnect mechanism includes a second switch set, which includes two pairs of contacts for connecting the phase and neutral conductors of the second and third electrical conductive paths, respectively. The two pairs of the first switch set and the two pairs of the second switch set are separated by an appropriate distance so that the arcs generated by the four sets of contacts during operation are not too concentrated in a small space.

It is to be understood that both the foregoing general description and the following detailed description are exemplary and explanatory and are intended to provide further explanation of the invention as claimed.

### BRIEF DESCRIPTION OF THE DRAWINGS

In the following drawing figures, like or identical components are labeled with like or identical symbols.

FIG. 1 is a circuit diagram of a circuit interrupter device according to an embodiment of the present invention.

FIG. 2 is a cross-sectional view of a circuit interrupter in a disconnected state according to an embodiment of the present invention.

FIG. 3 is a cross-sectional view of a circuit interrupter of the embodiment of FIG. 2 in a normal state.

FIG. 4 is a circuit diagram of a circuit interrupter device according to another embodiment of the present invention.

FIG. 5 is a circuit diagram of a circuit interrupter device according to another embodiment of the present invention.

FIG. 6 is a cross-sectional view of a circuit interrupter in a disconnected state according to another embodiment of the present invention.

FIG. 7 is a cross-sectional view of a circuit interrupter of the embodiment of FIG. 6 in a normal state.

FIGS. 8-10 are circuit diagrams of circuit interrupter devices according to other embodiments of the present invention.

### DETAILED DESCRIPTION OF THE PREFERRED EMBODIMENTS

Detailed descriptions of the preferred embodiments are provided below, but the invention is not limited to these embodiments.

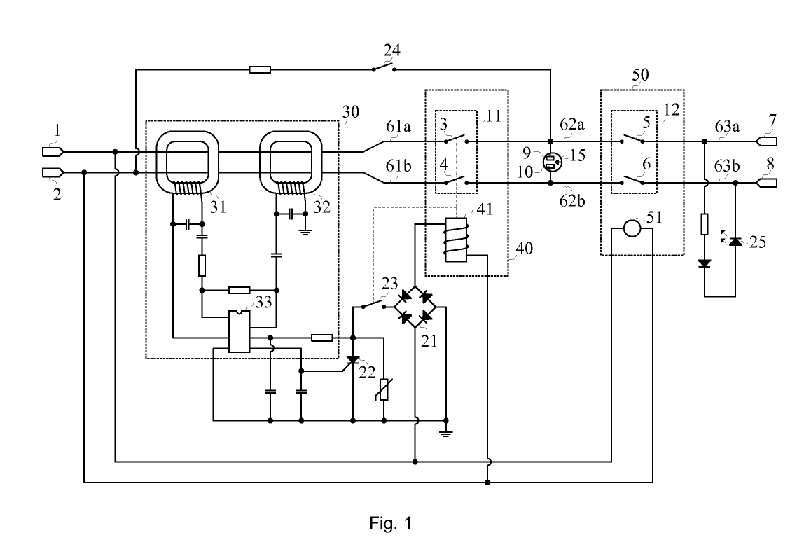

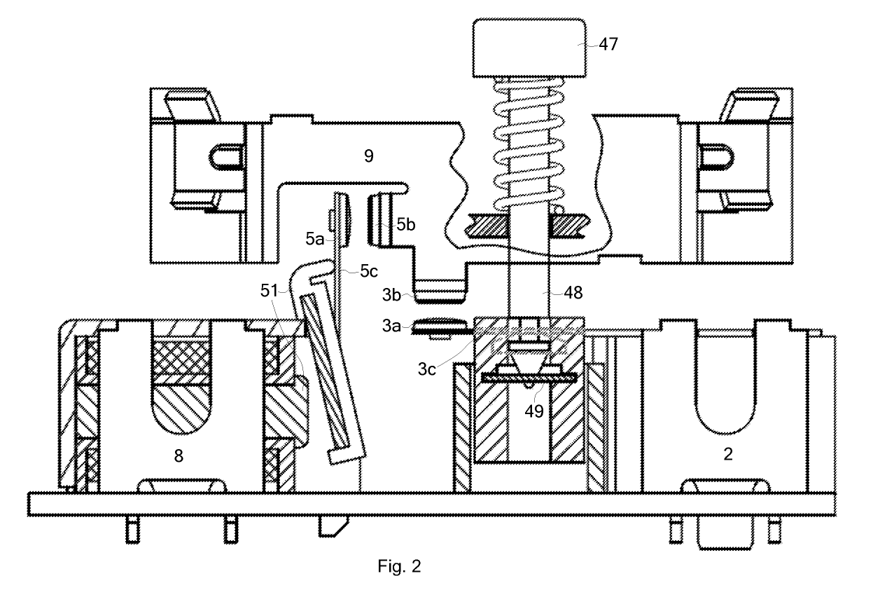

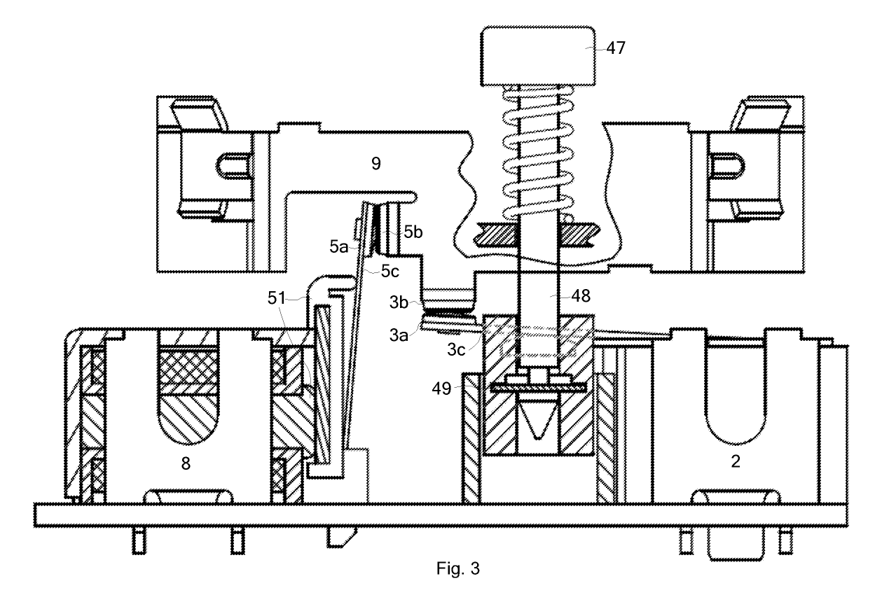

FIG. 1 is a circuit diagram of a circuit interrupter device according to an embodiment of the present invention. FIG. 2 is a cross-sectional view of this embodiment in a disconnected state. FIG. 3 is a cross-sectional view of this embodiment in a normal state. This embodiment is described with respect to FIGS. 1-3.

As shown in FIG. 1, the circuit interrupter includes a first electrical conductive path, a second electrical conductive path, a third electrical conductive path, a fault detection circuit 30, a first disconnect mechanism 40, and a second disconnect mechanism 50. The first electrical conductive path includes a phase conductor 61a and a neutral conductor 61b connected to an input phase terminal 1 and an input neutral terminal 2, respectively. The second electrical conductive path includes a phase conductor 62a and a neutral conductor 62b connected to a load receptacle 15, where the phase conductor 62a is connected to the phase conductor plate 9 and the neutral conductor 62b is connected to the neutral conductor plate 10 of the load receptacle 15. The third electrical conductive path includes a phase conductor 63a and a neutral conductor 63b connected to an output phase terminal 7 and an output neutral terminal 8, respectively. The fault detection circuit 30 generates a fault detection signal based on a fault detected in at least the first electrical conductive path. The first disconnect mechanism 40 is connected to the fault detection circuit 30, and operates to disconnect the first electrical conductive path and the second electrical conductive path based on the fault detection signal. The second disconnect mechanism 50 is connected to the first electrical conductive path, and operates to connect or disconnect the second electrical conductive path and the third electrical conductive path based on a wiring condition as described in more detail later.

The fault detection circuit 30 includes detection rings 31, 32 and a control IC 33. The control IC may be, for example, an RV4140 chip, RV4145 chip, etc. The fault detection circuit 30 may also employ a single ring.

The first disconnect mechanism 40 includes a first switch set 11 and a solenoid 41. The first switch set 11 includes a first switch 3 and a second switch 4. The first switch 3 connects the phase conductor 61a of the first electrical conductive path and the phase conductor 62a of the second electrical conductive path. The second switch 4 connects the neutral conductor 61b of the first electrical conductive path and the neutral conductor 62b of the second electrical conductive path. When the fault detection circuit 30 generates a fault signal, the first disconnect mechanism 40 disconnects the first switch set 11 to disconnect the first electrical conductive path and the second electrical conductive path from each other.

The second disconnect mechanism 50 includes a second switch set 11 and an electrical actuator 51. The second switch set 12 includes a third switch 5 and a fourth switch 6. The third switch 5 connects the phase conductor 62a of the second electrical conductive path and the phase conductor 63a of the third electrical conductive path. The fourth switch 6 connects the neutral conductor 62b of the second electrical conductive path and the neutral conductor 63b of the third electrical conductive path. The actuator 51 is connected to the first electrical conductive path. When the input phase terminal 1 and the input neutral terminal 2 are correctly connected to a power source, the actuator 51 is energized and closes the second switch set 12, thereby electrically connecting the second electrical conductive path and the third electrical conductive path. When the input phase terminal 1 and the input neutral terminal 2 are not connected to a power source, the actuator 51 is not energized, and the second switch set 12 remain open, thereby electrically disconnecting the second electrical conductive path and the third electrical conductive path.

FIGS. 2 and 3 illustrate the phase conductor plate 9 of the load receptacle 15, the input neutral terminal 2 and output neutral terminal 8. Portions of the first disconnect mechanism 40 and the second disconnect mechanism 50 are illustrated in FIGS. 2 and 3. The first disconnect mechanism 40 includes a reset button 47, a reset shaft 48 coupled to the reset button 47, a locking member 49, and the first switch set 11. The first switch set 11 includes switches 3 and 4. Switch 3 is formed by a movable arm 3c, a movable contact 3a on one end of the movable arm 3c, and a stationary contact 3b corresponding to the movable contact 3a. The other end of the movable arm 3c is electrically connected to the input phase terminal 1 via the phase conductor 61a of the first electrical conductive path. The stationary contact 3b is electrically connected to the phase conductor 62a of the second electrical conductive path and the phase conductor plate 9 of the receptacle 15. The structure of switch 4 is similar to that of switch 3. The second disconnect mechanism 50 includes the actuator 51 and the second switch set 12. The second switch set 12 includes switches 5 and 6. Switch 5 is formed by a movable arm 5c, a movable contact 5a on one end of the movable arm 5c, and a stationary contact 5b corresponding to the movable contact 5a. The other end of the movable arm 5c is electrically connected to the output phase terminal 7 via the phase conductor 63a of the third electrical conductive path. The stationary contact 5b is electrically connected to the phase conductor 62a of the second electrical conductive path and the phase conductor plate 9 of the receptacle 15. The structure of switch 6 is similar to that of switch 5.

During installation, when the power source is incorrectly connected to output phase terminal 7 and output neutral terminal 8 (i.e. the circuit interrupter is reverse-wired), because the actuator 51 is not energized, the second switch set 12 remains open. Thus, the first electrical conductive path and the second electrical conductive path are not powered, which accomplishes reverse-wiring protection.

During installation, when the power source is correctly connected to the input phase terminal 1 and an input neutral terminal 2, the actuator 51 is energized and drives the movable arm 5c to move. As a result, the movable contact 5a contacts the stationary contact 5b, closing the switch 5. The switch 6 is closed in a similar manner. This accomplishes the electrical connection between the second electrical conductive path and the third electrical conductive path. From this initial state, when the reset button 47 is pressed down, a groove on the reset shaft 48 engages the locking member 49. When the reset button 47 is released, the reset shaft 48 is urged by a spring to move upwards, bringing the locking member 49 upwards with it. As a result, the movable arm 3c is lifted, making the movable contact 3a contact the stationary contact 3b, closing the switch 3. Switch 4 is closed in a similar manner. This accomplishes the electrical connection between the first electrical conductive path and the second electrical conductive path. The first electrical conductive path is electrically connected to the second electrical conductive path, and the second electrical conductive path is electrically connected to the third electrical conductive path; the circuit interrupter device is in a normal working condition.

An auxiliary switch 23 is connected at one end to the first electrical conductive path and connected at the other end to the fault detection circuit 30. The auxiliary switch is mechanically designed to open and close in synchrony with switches 3 and 4. When switches 3 and 4 are closed, switch 23 is closed and the fault detection circuit 30 is powered and can operate normally. When switches 3 and 4 are open, switch 23 is open and the fault detection circuit 30 stops working to conserve energy.

The electrical actuator 51 is an AC device, such as an AC electromagnetic relay.

The circuit interrupter is designed so that the two sets of contacts 3a, 3b, 4a and 4b of the first switch set 11 and the two sets of contacts 5a, 5b, 6a and 6b of the second switch set 12 are separated by an appropriate distance, so that the arcs generated by the four sets of contacts during operation are not too concentrated in a small space. This reduces the impact on the insulating properties of the electrical components and plastic parts inside the circuit interrupter devices and helps to extend the life of the devices.

When a leakage current or other problem causes the current imbalance between the phase conductor 61a and a neutral conductor 61b to exceed a predetermined threshold, the fault detection circuit 30 generates a fault detection signal. The signal is applied to the control electrode of a silicon-controlled rectifier (SCR) 22 to trigger the SCR into a conducting state. A large current passes through the solenoid 41 to energize it, and a plunder in the solenoid moves to push the locking member 49. This causes the reset shaft 48 to be disengaged from the locking member 49, and the movable arm 3c falls with the locking member 49 to its original (disconnected) state, thereby opening the first switch set 11. In one complete cycle of reset and disconnection (also referred to as tripping), the solenoid experiences a large current only once, which helps to extend the life of the solenoid.

A test switch 24 is connected between the first electrical conductive path and the second electrical conductive path. One end of the test switch 24 is connected to a phase conductor and the other end is connected to a neutral conductor. When the test switch 24 is closed, a simulated leakage current is generated, and the fault detection circuit 30 generates a fault detection signal to cause the first switch set 11 to become open.

A light emitting diode 25 is connected between the phase conductor 63a and a neutral conductor 63b of the third electrical conductive path to indicate the working condition of the circuit interrupter.

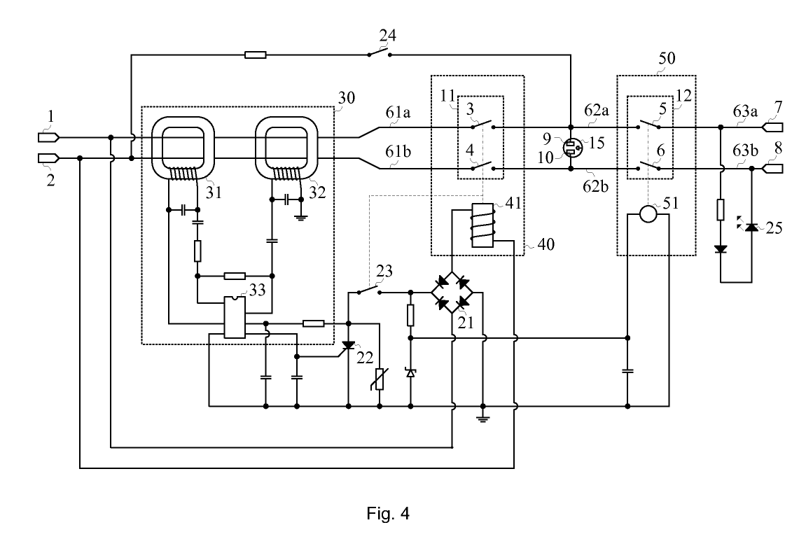

FIG. 4 is a circuit diagram of a circuit interrupter device according to another embodiment of the present invention. A main difference between the circuit of FIG. 1 and the circuit of FIG. 4 is that the electrical actuator 51 is connected differently. In the embodiment of FIG. 4, the actuator 51 is a DC device, such as a DC electromagnetic relay. Its one end is connected to the DC output of the diode bridge 21 and its other end is connected to ground. The mechanical structure of the circuit interrupter of FIG. 4 is similar to that shown in FIGS. 2 and 3.

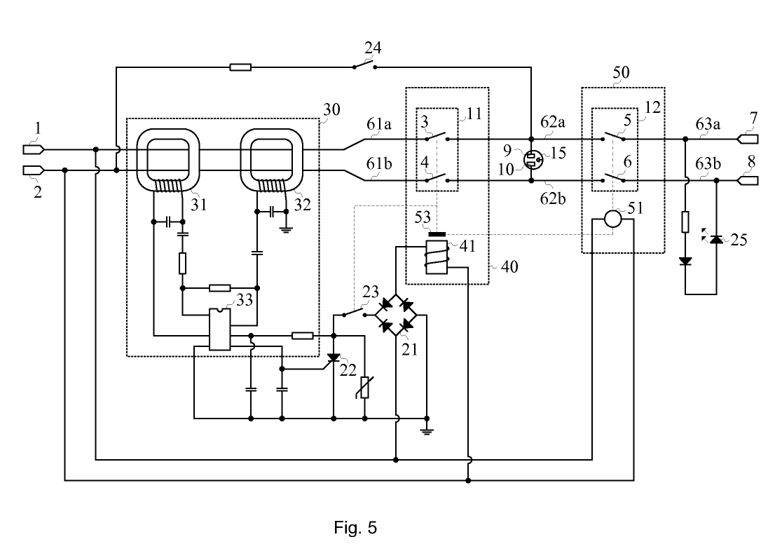

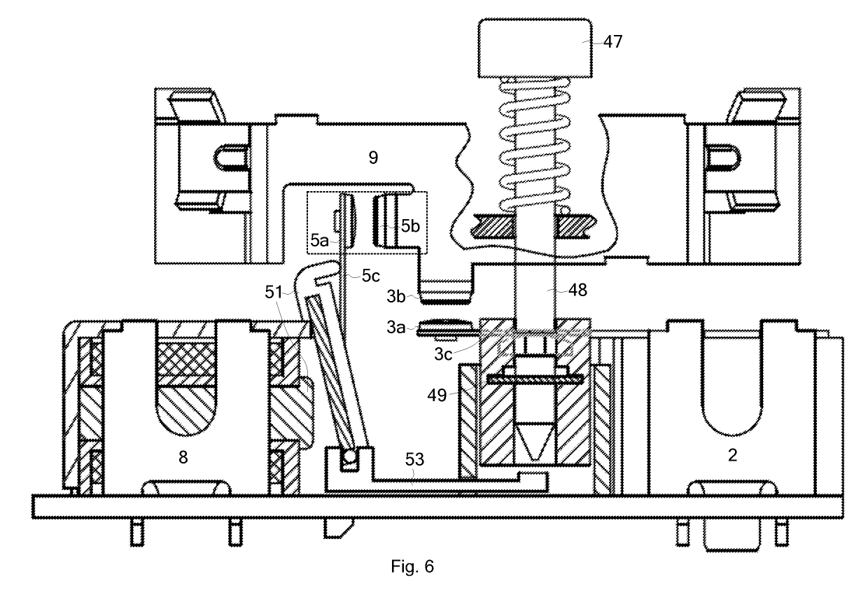

FIG. 5 is a circuit diagram of a circuit interrupter device according to another embodiment of the present invention. FIG. 6 is a cross-sectional view of this embodiment in a disconnected state. FIG. 3 is a cross-sectional view of this embodiment in a normal state. This embodiment is described with respect to FIGS. 1-3.

As shown in FIG. 5, the circuit interrupter of this embodiment includes a first electrical conductive path, a second electrical conductive path, a third electrical conductive path, a fault detection circuit 30, a first disconnect mechanism 40, a second disconnect mechanism 50, and a operation control mechanism 53. The first electrical conductive path includes a phase conductor 61a and a neutral conductor 61b connected to an input phase terminal 1 and an input neutral terminal 2, respectively. The second electrical conductive path includes a phase conductor 62a and a neutral conductor 62b connected to a load receptacle 15, where the phase conductor 62a is connected to the phase conductor plate 9 and the neutral conductor 62b is connected to the neutral conductor plate 10 of the load receptacle 15. The third electrical conductive path includes a phase conductor 63a and a neutral conductor 63b connected to an output phase terminal 7 and an output neutral terminal 8, respectively. The fault detection circuit 30 generates a fault detection signal based on a fault detected in at least the first electrical conductive path. The first disconnect mechanism 40 is connected to the fault detection circuit 30, and operates to disconnect the first electrical conductive path and the second electrical conductive path based on the fault detection signal. The second disconnect mechanism 50 is connected to the first electrical conductive path, and operates to connect or disconnect the second electrical conductive path and the third electrical conductive path based on a wiring condition as described in more detail later. The operation control mechanism 53 is mechanically coupled to, and moves in synchrony with, the second disconnect mechanism 50 to enable or disable the first disconnect mechanism 40.

The fault detection circuit 30 includes detection rings 31, 32 and a control IC 33. The control IC may be, for example, an RV4140 chip, RV4145 chip, etc. The fault detection circuit 30 may also employ a single ring.

The first disconnect mechanism 40 includes a first switch set 11 and a solenoid 41. The first switch set 11 includes a first switch 3 and a second switch 4. The first switch 3 connects the phase conductor 61a of the first electrical conductive path and the phase conductor 62a of the second electrical conductive path. The second switch 4 connects the neutral conductor 61b of the first electrical conductive path and the neutral conductor 62b of the second electrical conductive path. When the fault detection circuit 30 generates a fault signal, the first disconnect mechanism 40 disconnects the first switch set 11 to disconnect the first electrical conductive path and the second electrical conductive path from each other.

The second disconnect mechanism 50 includes a second switch set 11 and an electrical actuator 51. The second switch set 12 includes a third switch 5 and a fourth switch 6. The third switch 5 connects the phase conductor 62a of the second electrical conductive path and the phase conductor 63a of the third electrical conductive path. The fourth switch 6 connects the neutral conductor 62b of the second electrical conductive path and the neutral conductor 63b of the third electrical conductive path. The actuator 51 is connected to the first electrical conductive path. When the input phase terminal 1 and the input neutral terminal 2 are correctly connected to a power source, the actuator 51 is energized and closes the second switch set 12, thereby electrically connecting the second electrical conductive path and the third electrical conductive path. When the input phase terminal 1 and the input neutral terminal 2 are not connected to a power source, the actuator 51 is not energized, and the second switch set 12 remain open, thereby electrically disconnecting the second electrical conductive path and the third electrical conductive path.

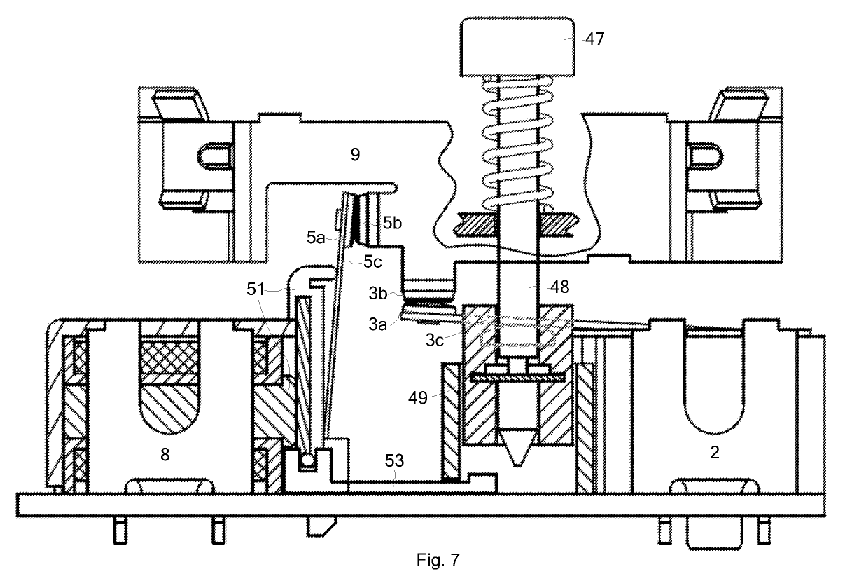

FIGS. 6 and 7 illustrate the phase conductor plate 9 of the load receptacle 15, the input neutral terminal 2 and output neutral terminal 8. Portions of the first disconnect mechanism 40, the second disconnect mechanism 50 and the operation control mechanism 53 are illustrated in FIGS. 6 and 7. The first disconnect mechanism 40 includes a reset button 47, a reset shaft 48 coupled to the reset button 47, a locking member 49, and the first switch set 11. The first switch set 11 includes switches 3 and 4. Switch 3 is formed by a movable arm 3c, a movable contact 3a on one end of the movable arm 3c, and a stationary contact 3b corresponding to the movable contact 3a. The other end of the movable arm 3c is electrically connected to the input phase terminal 1 via the phase conductor 61a of the first electrical conductive path. The stationary contact 3b is electrically connected to the phase conductor 62a of the second electrical conductive path and the phase conductor plate 9 of the receptacle 15. The structure of switch 4 is similar to that of switch 3. The second disconnect mechanism 50 includes the actuator 51 and the second switch set 12. The second switch set 12 includes switches 5 and 6. Switch 5 is formed by a movable arm 5c, a movable contact 5a on one end of the movable arm 5c, and a stationary contact 5b corresponding to the movable contact 5a. The other end of the movable arm 5c is electrically connected to the output phase terminal 7 via the phase conductor 63a of the third electrical conductive path. The stationary contact 5b is electrically connected to the phase conductor 62a of the second electrical conductive path and the phase conductor plate 9 of the receptacle 15. The structure of switch 6 is similar to that of switch 5.

During installation, when the power source is incorrectly connected to output phase terminal 7 and output neutral terminal 8 (i.e. the circuit interrupter is reverse-wired), because the actuator 51 is not energized, the second switch set 12 remains open. Thus, the first electrical conductive path and the second electrical conductive path are not powered, which accomplishes reverse-wiring protection. In the mean time, the operation control mechanism 53 prevents the downward movement of the reset shaft 48, so that the groove of the reset shaft 48 cannot engage with the locking member 49, and switches 3 and 4 cannot be closed. In this state, the reset button 47 cannot be pressed down to reset the circuit interrupter device. The ability or inability to press down the reset button can help a user determine the current working condition of the circuit interrupter.

During installation, when the power source is correctly connected to the input phase terminal 1 and an input neutral terminal 2, the actuator 51 is energized and drives the movable arm 5c to move. As a result, the movable contact 5a contacts the stationary contact 5b, closing the switch 5. The switch 6 is closed in a similar manner. This accomplishes the electrical connection between the second electrical conductive path and the third electrical conductive path. In the mean time, the actuator 51 drives the operation control mechanism 53 to move out of the way of the reset shaft 48, so that the reset button 47 can be pressed down. From this initial state, when the reset button 47 is pressed down, a groove on the reset shaft 48 engages the locking member 49. When the reset button 47 is released, the reset shaft 48 is urged by a spring to move upwards, bringing the locking member 49 upwards with it. As a result, the movable arm 3c is lifted, making the movable contact 3a contact the stationary contact 3b, closing the switch 3. Switch 4 is closed in a similar manner. This accomplishes the electrical connection between the first electrical conductive path and the second electrical conductive path. The first electrical conductive path is electrically connected to the second electrical conductive path, and the second electrical conductive path is electrically connected to the third electrical conductive path; the circuit interrupter device is in a normal working condition.

An auxiliary switch 23 is connected at one end to the first electrical conductive path and connected at the other end to the fault detection circuit 30. The auxiliary switch is mechanically designed to open and close in synchrony with switches 3 and 4. When switches 3 and 4 are closed, switch 23 is closed and the fault detection circuit 30 is powered and can operate normally. When switches 3 and 4 are open, switch 23 is open and the fault detection circuit 30 stops working to conserve energy.

The electrical actuator 51 is an AC device, such as an AC electromagnetic relay.

The circuit interrupter is designed so that the two sets of contacts 3a, 3b, 4a and 4b of the first switch set 11 and the two sets of contacts 5a, 5b, 6a and 6b of the second switch set 12 are separated by an appropriate distance, so that the arcs generated by the four sets of contacts during operation are not too concentrated in a small space. This reduces the impact on the insulating properties of the electrical components and plastic parts inside the circuit interrupter devices and helps to extend the life of the devices.

When a leakage current or other problem causes the current imbalance between the phase conductor 61a and a neutral conductor 61b to exceed a predetermined threshold, the fault detection circuit 30 generates a fault detection signal. The signal is applied to the control electrode of a silicon-controlled rectifier (SCR) 22 to trigger the SCR into a conducting state. A large current passes through the solenoid 41 to energize it, and a plunder in the solenoid moves to push the locking member 49. This causes the reset shaft 48 to be disengaged from the locking member 49, and the movable arm 3c falls with the locking member 49 to its original (disconnected) state, thereby opening the first switch set 11. In one complete cycle of reset and disconnection (also referred to as tripping), the solenoid experiences a large current only once, which helps to extend the life of the solenoid.

A test switch 24 is connected between the first electrical conductive path and the second electrical conductive path. One end of the test switch 24 is connected to a phase conductor and the other end is connected to a neutral conductor. When the test switch 24 is closed, a simulated leakage current is generated, and the fault detection circuit 30 generates a fault detection signal to cause the first switch set 11 to become open.

A light emitting diode 25 is connected between the phase conductor 63a and a neutral conductor 63b of the third electrical conductive path to indicate the working condition of the circuit interrupter.

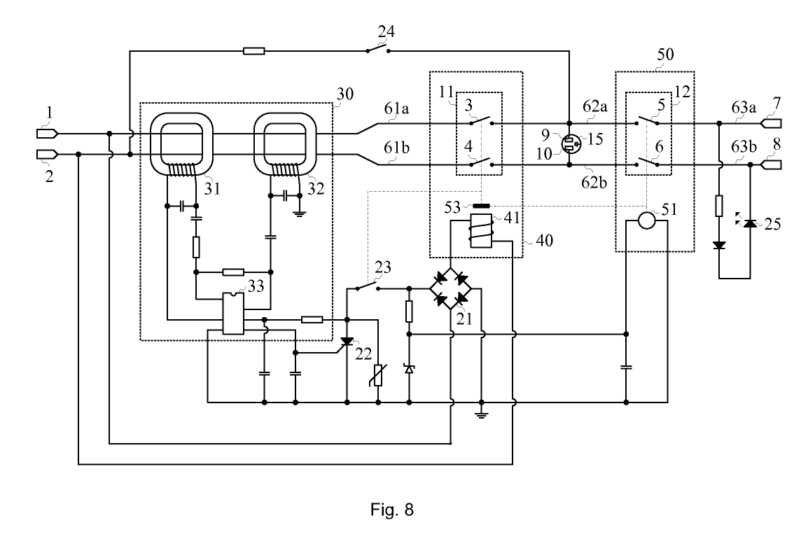

FIG. 8 is a circuit diagram of a circuit interrupter device according to another embodiment of the present invention. A main difference between the circuit of FIG. 5 and the circuit of FIG. 8 is that the electrical actuator 51 is connected differently. In the embodiment of FIG. 8, the actuator 51 is a DC device, such as a DC electromagnetic relay. Its one end is connected to the DC output of the diode bridge 21 and its other end is connected to ground. The mechanical structure of the circuit interrupter of FIG. 8 is similar to that shown in FIGS. 6 and 7.

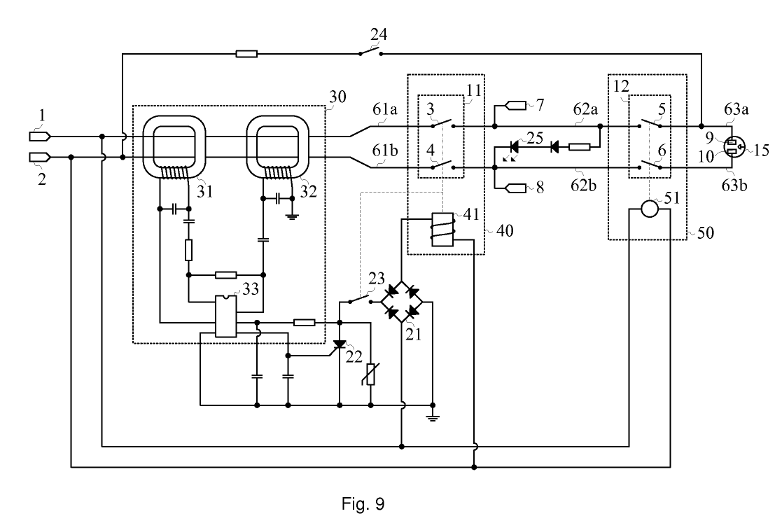

FIG. 9 is a circuit diagram of a circuit interrupter device according to another embodiment of the present invention.

As shown in FIG. 9, the circuit interrupter includes a first electrical conductive path, a second electrical conductive path, a third electrical conductive path, a fault detection circuit 30, a first disconnect mechanism 40, and a second disconnect mechanism 50. The first electrical conductive path includes a phase conductor 61a and a neutral conductor 61b connected to an input phase terminal 1 and an input neutral terminal 2, respectively. The second electrical conductive path includes a phase conductor 62a and a neutral conductor 62b connected to an output phase terminal 7 and an output neutral terminal 8, respectively. The third electrical conductive path includes a phase conductor 63a and a neutral conductor 63b connected to a load receptacle 15, where the phase conductor 63a is connected to the phase conductor plate 9 and the neutral conductor 63b is connected to the neutral conductor plate 10 of the load receptacle 15. The fault detection circuit 30 generates a fault detection signal based on a fault detected in at least the first electrical conductive path. The first disconnect mechanism 40 is connected to the fault detection circuit 30, and operates to disconnect the first electrical conductive path and the second electrical conductive path based on the fault detection signal. The second disconnect mechanism 50 is connected to the first electrical conductive path, and operates to connect or disconnect the second electrical conductive path and the third electrical conductive path based on a wiring condition as described in more detail later.

The fault detection circuit 30 includes detection rings 31, 32 and a control IC 33. The control IC may be, for example, an RV4140 chip, RV4145 chip, etc. The fault detection circuit 30 may also employ a single ring.

The first disconnect mechanism 40 includes a first switch set 11 and a solenoid 41. The first switch set 11 includes a first switch 3 and a second switch 4. The first switch 3 connects the phase conductor 61a of the first electrical conductive path and the phase conductor 62a of the second electrical conductive path. The second switch 4 connects the neutral conductor 61b of the first electrical conductive path and the neutral conductor 62b of the second electrical conductive path. When the fault detection circuit 30 generates a fault signal, the first disconnect mechanism 40 disconnects the first switch set 11 to disconnect the first electrical conductive path and the second electrical conductive path from each other.

The second disconnect mechanism 50 includes a second switch set 11 and an electrical actuator 51. The second switch set 12 includes a third switch 5 and a fourth switch 6. The third switch 5 connects the phase conductor 62a of the second electrical conductive path and the phase conductor 63a of the third electrical conductive path. The fourth switch 6 connects the neutral conductor 62b of the second electrical conductive path and the neutral conductor 63b of the third electrical conductive path. The actuator 51 is connected to the first electrical conductive path. When the input phase terminal 1 and the input neutral terminal 2 are correctly connected to a power source, the actuator 51 is energized and closes the second switch set 12, thereby electrically connecting the second electrical conductive path and the third electrical conductive path. When the input phase terminal 1 and the input neutral terminal 2 are not connected to a power source, the actuator 51 is not energized, and the second switch set 12 remain open, thereby electrically disconnecting the second electrical conductive path and the third electrical conductive path.

During installation, when the power source is incorrectly connected to output phase terminal 7 and output neutral terminal 8 (i.e. the circuit interrupter is reverse-wired), because the actuator 51 is not energized, the second switch set 12 remains open. Thus, the first electrical conductive path and the third electrical conductive path are not powered, which accomplishes reverse-wiring protection.

During installation, when the power source is correctly connected to the input phase terminal 1 and an input neutral terminal 2, the actuator 51 is energized to close the switches 5 and 6. This accomplishes the electrical connection between the second electrical conductive path and the third electrical conductive path. From this initial state, when the reset button is pressed down, switches 3 and 4 are closed. This accomplishes the electrical connection between the first electrical conductive path and the second electrical conductive path. The first electrical conductive path is electrically connected to the second electrical conductive path, and the second electrical conductive path is electrically connected to the third electrical conductive path; the circuit interrupter device is in a normal working condition.

An auxiliary switch 23 is connected at one end to the first electrical conductive path and connected at the other end to the fault detection circuit 30. The auxiliary switch is mechanically designed to open and close in synchrony with switches 3 and 4. When switches 3 and 4 are closed, switch 23 is closed and the fault detection circuit 30 is powered and can operate normally. When switches 3 and 4 are open, switch 23 is open and the fault detection circuit 30 stops working to conserve energy.

The electrical actuator 51 is an AC device, such as an AC electromagnetic relay.

When a leakage current or other problem causes the current imbalance between the phase conductor 61a and a neutral conductor 61b to exceed a predetermined threshold, the fault detection circuit 30 generates a fault detection signal. The signal is applied to the control electrode of a silicon-controlled rectifier (SCR) 22 to trigger the SCR into a conducting state. A large current passes through the solenoid 41 to energize it, driving other components of the first disconnect mechanism 40 to open the first switch set 11. In one complete cycle of reset and disconnection (also referred to as tripping), the solenoid experiences a large current only once, which helps to extend the life of the solenoid.

A test switch 24 is connected between the first electrical conductive path and the second electrical conductive path. One end of the test switch 24 is connected to a phase conductor and the other end is connected to a neutral conductor. When the test switch 24 is closed, a simulated leakage current is generated, and the fault detection circuit 30 generates a fault detection signal to cause the first switch set 11 to become open.

A light emitting diode 25 is connected between the phase conductor 62a and a neutral conductor 62b of the second electrical conductive path to indicate the working condition of the circuit interrupter.

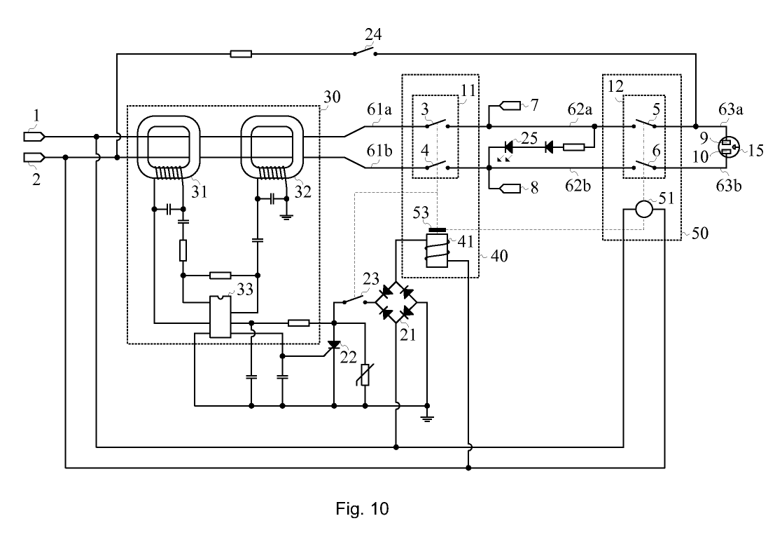

FIG. 10 is a circuit diagram of a circuit interrupter device according to another embodiment of the present invention.

As shown in FIG. 10, the circuit interrupter of this embodiment includes a first electrical conductive path, a second electrical conductive path, a third electrical conductive path, a fault detection circuit 30, a first disconnect mechanism 40, a second disconnect mechanism 50, and a operation control mechanism 53. The first electrical conductive path includes a phase conductor 61a and a neutral conductor 61b connected to an input phase terminal 1 and an input neutral terminal 2, respectively. The second electrical conductive path includes a phase conductor 62a and a neutral conductor 62b connected to an output phase terminal 7 and an output neutral terminal 8, respectively. The third electrical conductive path includes a phase conductor 63a and a neutral conductor 63b connected to a load receptacle 15, where the phase conductor 63a is connected to the phase conductor plate 9 and the neutral conductor 63b is connected to the neutral conductor plate 10 of the load receptacle 15. The fault detection circuit 30 generates a fault detection signal based on a fault detected in at least the first electrical conductive path. The first disconnect mechanism 40 is connected to the fault detection circuit 30, and operates to disconnect the first electrical conductive path and the second electrical conductive path based on the fault detection signal. The second disconnect mechanism 50 is connected to the first electrical conductive path, and operates to connect or disconnect the second electrical conductive path and the third electrical conductive path based on a wiring condition as described in more detail later. The operation control mechanism 53 is mechanically coupled to, and moves in synchrony with, the second disconnect mechanism 50 to enable or disable the first disconnect mechanism 40.

The fault detection circuit 30 includes detection rings 31, 32 and a control IC 33. The control IC may be, for example, an RV4140 chip, RV4145 chip, etc. The fault detection circuit 30 may also employ a single ring.

The first disconnect mechanism 40 includes a first switch set 11 and a solenoid 41. The first switch set 11 includes a first switch 3 and a second switch 4. The first switch 3 connects the phase conductor 61a of the first electrical conductive path and the phase conductor 62a of the second electrical conductive path. The second switch 4 connects the neutral conductor 61b of the first electrical conductive path and the neutral conductor 62b of the second electrical conductive path. When the fault detection circuit 30 generates a fault signal, the first disconnect mechanism 40 disconnects the first switch set 11 to disconnect the first electrical conductive path and the second electrical conductive path from each other.

The second disconnect mechanism 50 includes a second switch set 11 and an electrical actuator 51. The second switch set 12 includes a third switch 5 and a fourth switch 6. The third switch 5 connects the phase conductor 62a of the second electrical conductive path and the phase conductor 63a of the third electrical conductive path. The fourth switch 6 connects the neutral conductor 62b of the second electrical conductive path and the neutral conductor 63b of the third electrical conductive path. The actuator 51 is connected to the first electrical conductive path. When the input phase terminal 1 and the input neutral terminal 2 are correctly connected to a power source, the actuator 51 is energized and closes the second switch set 12, thereby electrically connecting the second electrical conductive path and the third electrical conductive path. When the input phase terminal 1 and the input neutral terminal 2 are not connected to a power source, the actuator 51 is not energized, and the second switch set 12 remain open, thereby electrically disconnecting the second electrical conductive path and the third electrical conductive path.

During installation, when the power source is incorrectly connected to output phase terminal 7 and output neutral terminal 8 (i.e. the circuit interrupter is reverse-wired), because the actuator 51 is not energized, the second switch set 12 remains open. Thus, the first electrical conductive path and the third electrical conductive path are not powered. In the mean time, because the actuator 51 is not energized and does not move the operation control mechanism 53, the operation control mechanism 53 prevents the downward movement of the reset shaft 48, so that switches 3 and 4 cannot be closed. In this state, the reset button 47 cannot be pressed down to reset the circuit interrupter device. As a result, the first electrical conductive path cannot be powered, which accomplished reverse-wiring protection. The ability or inability to press down the reset button can help a user determine the current working condition of the circuit interrupter.

During installation, when the power source is correctly connected to the input phase terminal 1 and an input neutral terminal 2, the actuator 51 is energized to close the switches 5 and 6. This accomplishes the electrical connection between the second electrical conductive path and the third electrical conductive path. In the mean time, the actuator drives the operation control mechanism 53 to move out of the way of the reset shaft 48, so that the reset button 47 can be pressed down. From this initial state, when the reset button 47 is pressed down, the switches 3 and 4 are closed. This accomplishes the electrical connection between the first electrical conductive path and the second electrical conductive path. The first electrical conductive path is electrically connected to the second electrical conductive path, and the second electrical conductive path is electrically connected to the third electrical conductive path; the circuit interrupter device is in a normal working condition.

An auxiliary switch 23 is connected at one end to the first electrical conductive path and connected at the other end to the fault detection circuit 30. The auxiliary switch is mechanically designed to open and close in synchrony with switches 3 and 4. When switches 3 and 4 are closed, switch 23 is closed and the fault detection circuit 30 is powered and can operate normally. When switches 3 and 4 are open, switch 23 is open and the fault detection circuit 30 stops working to conserve energy.

The electrical actuator 51 is an AC device, such as an AC electromagnetic relay.

When a leakage current or other problem causes the current imbalance between the phase conductor 61a and a neutral conductor 61b to exceed a predetermined threshold, the fault detection circuit 30 generates a fault detection signal. The signal is applied to the control electrode of a silicon-controlled rectifier (SCR) 22 to trigger the SCR into a conducting state. A large current passes through the solenoid 41 to energize it, driving various components of the first disconnect mechanism 40 to open the first switch set 11. In one complete cycle of reset and disconnection, the solenoid experiences a large current only once, which helps to extend the life of the solenoid.

A test switch 24 is connected between the first electrical conductive path and the second electrical conductive path. One end of the test switch 24 is connected to a phase conductor and the other end is connected to a neutral conductor. When the test switch 24 is closed, a simulated leakage current is generated, and the fault detection circuit 30 generates a fault detection signal to cause the first switch set 11 to become open.

A light emitting diode 25 is connected between the phase conductor 62a and a neutral conductor 62b of the second electrical conductive path to indicate the working condition of the circuit interrupter.

It will be apparent to those skilled in the art that various modification and variations can be made in the circuit interrupter device of the present invention without departing from the spirit or scope of the invention. Thus, it is intended that the present invention cover modifications and variations that come within the scope of the appended claims and their equivalents.

What is claimed is:

1. A circuit interrupter device, comprising:
a first, a second and a third electrical conductive path;
a fault detection circuit for generating a fault detection signal based on a fault detected in at least the first electrical conductive path;
a first disconnect mechanism connected to the fault detection circuit, for disconnecting the first electrical conductive path and the second electrical conductive path based on the fault detection signal; and
a second disconnect mechanism connected to the first electrical conductive path, for connecting or disconnecting the second electrical conductive path and the third electrical conductive path based on a wiring condition of the circuit interrupter device.

2. The circuit interrupter device of claim 1, wherein the first electrical conductive path is connected to at least one input terminal, the second electrical conductive path is connected to at least one load, and the third electrical conductive path is connected to at least one output terminal.

3. The circuit interrupter device of claim 1, wherein the first electrical conductive path is connected to at least one input terminal, the second electrical conductive path is connected to at least one output terminal, and the third electrical conductive path is connected to at least one load.

4. The circuit interrupter device of claim 1, wherein the first disconnect mechanism includes a first switch set connecting the first electrical conductive path and the second electrical conductive path, the first switch set being open based on the fault detection signal.

5. The circuit interrupter device of claim 4, wherein the first switch set includes a first pair and a second pair of contacts, the first pair of contacts for connecting a phase conductor of the first electrical conductive path and a phase conductor of the second electrical conductive path, and the second pair of contacts for connecting a neutral conductor of the first electrical conductive path and a neutral conductor of the second electrical conductive path.

6. The circuit interrupter device of claim 5, wherein the first switch set includes two movable arms each having one end connected to the first electrical conductive path, wherein another end of the two movable arms has a first and a second movable contact disposed thereon, respectively, wherein the first switch set further includes a first and a second stationary contact, wherein the first movable contact and the first stationary contact form the first pair of contacts and the second movable contact and the second stationary contact form the second pair of contacts.

7. The circuit interrupter device of claim 4, wherein the second disconnect mechanism includes a second switch set connecting the second electrical conductive path and the third electrical conductive path.

8. The circuit interrupter device of claim 7, wherein the second switch set includes a third pair and a fourth pair of contacts, the third pair of contacts for connecting a phase conductor of the second electrical conductive path and a phase conductor of the third electrical conductive path, and the fourth pair of contacts for connecting a neutral conductor of the second electrical conductive path and a neutral conductor of the third electrical conductive path.

9. The circuit interrupter device of claim 8, wherein the second disconnect mechanism further includes an electrical actuator connected to the first electrical conductive path for closing and opening the second switch set based on the wiring condition of the circuit interrupter device.

10. The circuit interrupter device of claim 8, wherein the second switch set includes two movable arms each having one end connected to the third electrical conductive path, wherein another end of the two movable arms has a third and a fourth movable contact disposed thereon, respectively, wherein the second switch set further includes a third and a fourth stationary contact, wherein the third movable contact and the third stationary contact form the third pair of contacts and the fourth movable contact and the fourth stationary contact form the fourth pair of contacts.

11. The circuit interrupter device of claim 1, further comprising an operation control mechanism mechanically coupled to and moving in synchrony with the second disconnect mechanism to enable or disable the first disconnect mechanism.

12. The circuit interrupter device of claim 11, wherein the first disconnect mechanism includes a first switch set connecting the first electrical conductive path and the second electrical conductive path, the first switch set being open based on the fault detection signal;
wherein the second disconnect mechanism includes a second switch set and an electrical actuator connected to the first electrical conductive path, the second switch set connecting the second electrical conductive path and the third electrical conductive path, the electrical actuator closing and opening the second switch set based on the wiring condition of the circuit interrupter device.

13. The circuit interrupter device of claim 12, wherein when the first electrical conductive path is connected to a power source, the electrical actuator closes the second switch set and causes the operation control mechanism to enable the first disconnect mechanism, and
wherein when the first electrical conductive path is not connected to the power source, the electrical actuator opens the second switch set and causes the operation control mechanism to disable the first disconnect mechanism.

14. The circuit interrupter device of claim 13, wherein the first switch set includes a first pair and a second pair of contacts, the first pair of contacts for connecting a phase conductor of the first electrical conductive path and a phase conductor of the second electrical conductive path, and the second pair of contacts for connecting a neutral conductor of the first electrical conductive path and a neutral conductor of the second electrical conductive path, and
wherein the second switch set includes a third pair and a fourth pair of contacts, the third pair of contacts for connecting a phase conductor of the second electrical conductive path and a phase conductor of the third electrical conductive path, and the fourth pair of contacts for connecting a neutral conductor of the second electrical conductive path and a neutral conductor of the third electrical conductive path.

15. The circuit interrupter device of claim 14, wherein the first switch set includes two movable arms each having one end connected to the first electrical conductive path, wherein another end of the two movable arms has a first and a second movable contact disposed thereon, respectively, wherein the first switch set further includes a first and a second stationary contact, wherein the first movable contact and the first stationary contact form the first pair of contacts and the second movable contact and the second stationary contact form the second pair of contacts, and
wherein the second switch set includes two movable arms each having one end connected to the third electrical conductive path, wherein another end of the two movable arms has a third and a fourth movable contact disposed thereon, respectively, wherein the second switch set further includes a third and a fourth stationary contact, wherein the third movable contact and the third stationary contact form the third pair of contacts and the fourth movable contact and the fourth stationary contact form the fourth pair of contacts.

16. The circuit interrupter device of claim 1, further comprising an auxiliary switch connected between the first electrical conductive path and the fault detection circuit for supplying power from the first electrical conductive path to the fault detection circuit, wherein the auxiliary switch is closed when the first switch set is closed and open when the first switch set is open.

17. The circuit interrupter device of claim 1, further comprising a test switch connected at one end to the first electrical conductive path and at another end to the second or third electrical conductive path for generating a simulated leakage current when the test switch is closed.
